(19) United States
(12) Patent Application Publication
(10) Pub. No.: US 2009/0081368 A1
(43) Pub. Date: Mar. 26, 2009

(54) METHOD FOR TREATING MINERAL SURFACES

(75) Inventors: Joachim Roser, Mannheim (DE); Andrea Eisenhardt, Vechta (DE); Hans Ulrich Schmidt, Osnabruck (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/282,891

(22) PCT Filed: Mar. 2, 2007
(86) PCT No.: PCT/EP2007/051987

§ 371 Date: Sep. 15, 2008

(30) Foreign Application Priority Data
Mar. 15, 2006 (EP) 06111181.1

(51) Int. Cl. B05D 3/12

(52) U.S. Cl. 427/299

(57) ABSTRACT

The invention provides a method of treating mineral surfaces, comprising the steps of

a) treating the mineral surfaces to remove soiling and
b) coating the surfaces with a plastic,
which comprises using as the plastic in step b) a transparent, compact-hydrophobic polyurethane preparable by reacting i) polyisocyanates with ii) compounds having at least two hydrogen atoms that are reactive with isocyanate groups.

The invention relates to a method of treating mineral surfaces, especially built structures.

The outer walls of built structures are subject to ageing over time. As a result of environmental influences, but also as a result of damage, such as graffiti, the buildings become unsightly over time. Thus in the area of facade cleaning, care of monuments, and restoration of natural stone, it is frequently necessary to remove soiling on sensitive substrates. In the case of large areas this is typically accomplished by means of water jet blasting, but preferably by sandblasting.

In order to prevent the surfaces rapidly becoming soiled again, they can be sealed after blasting. A variety of methods are known for protecting the surface of the stones.

For instance DE 199 42 243 describes an aqueous polyurethane resin dispersion with an adhesion promoter for sealing masonry. The purpose of the adhesion promoter is to enhance the adhesion to smooth surfaces. The coatings formed from the dispersions described are “breathable” but water-repellant.

DE 101 24 499 describes a coating material which is based on silicone resin and comprises fractions of comminuted stone material for surfaces. Since the silicone resin has a strong inherent color, the intention is for the stone material to give the surface stone optical qualities.

DE 39 39 566 describes stone protection materials which comprise alkoxysilane-terminated polyurethanes. The purpose of the stone protection materials is to give the stones not only hydrophobic but also hydrophilic properties.

DE 197 06 904 describes an impregnating material for mineral substrates which is based on compounds containing isocyanate groups. The impregnating material is intended to prevent the stones becoming hydrophobic. The impregnating compositions ought also to be useful for salt-containing stones.

EP 689 908 describes an aqueous dispersion of fluorinated polyurethanes which is intended to protect stones and concrete from environmental influences.

EP 1 170 271 describes a method of solidifying blocks of natural stone. It involves impregnating the block under vacuum with a plastic. The intention thereby is to enhance the strength of the block. This method, however, is costly and inconvenient, and is totally unsuitable for the renovation of buildings.

U.S. Pat. No. 4,810,533 describes the treatment of porous surfaces which have been damaged by environmental influences. It involves first treating the surface with a solvent in order to remove organic soiling. Thereafter the surface is blasted with sand and then treated with water in order to remove the loose particles. Subsequently the water is removed with an organic solvent and the surface is cleaned with a cloth. Finally a moisture-curing polyurethane is applied to the surface thus cleaned. The polyurethane can be applied using a brush, a nozzle or special rollers. This method is laborious and time-consuming.

It was an object of the invention to find a simple method of treating mineral surfaces that allows the elimination of damage and dirt and a durable protection of the surface against environmental effects, the intention being that the polyurethane should be pre-pared using customary and readily available raw materials.

This object has been achieved by virtue of the surface first being freed from soiling by waterblasting or, in particular, by sandblasting, and by the subsequent application to the surface of an aliphatic hydrophobic polyurethane.

The invention accordingly provides a method of treating mineral surfaces which comprises the steps of

a) treating the mineral surfaces to remove soiling and
b) coating the surface with a plastic, which comprises using as the plastic in step b) a transparent, compact hydrophobic polyurethane based on an aliphatic polyisocyanate.

In step a), as described, the mineral surface is freed from soiling. This can be done by methods which are common knowledge. Waterblasting and sandblasting have proven particularly effective.

In the case of waterblasting the kinetic energy of water under high stress is utilized for cleaning. The jet of water, emerging from narrow nozzles at high pressures (up to 300 MPa), strikes the surface, and in so doing leads to removal of the soiling from the surface.

Even more effective, and therefore particularly preferred, is sandblasting. Sandblasting refers to the cleaning of surfaces by the action of different kinds of granules, or blasting agents, which, under acceleration by compressed air or centrifugal force, are blasted onto the object to be cleaned. This is done either by spin blasting or compressed-air blasting in various embodiments. In the case of spin blasting, the blasting agent is ejected by rotating spin wheels in stationary units. Compressed-air blasting can be operated on a stationary or moving basis. Blasting agent is accelerated with compressed air and so strikes the blast substrate at a relatively high speed.

In one preferred embodiment quartz sand 0.5-1.5 mm in diameter is spun onto the surfaces to be cleaned, with the aid of compressed-air blowers (0.7 MPa).

In order to obtain a long-term improvement in the surface, in step b) a hydrophobic aliphatic polyurethane is applied to the surface. This application may take place conventionally, preferably by spraying. The thickness of the polyurethane coat is preferably 0.5 mm-1 cm, in particular 0.5 mm-3 mm.

Between steps a) and b) the surface may be cleaned. In this context it is possible for loose particles adhering to the surface, for example, to be removed mechanically, by means of brushing, by means of compressed air or by means of water, for example.

The polyurethane is preferably compact and transparent in order to prevent optical impairment of the surfaces, particularly in the case of facades of buildings. For the same reason use is made of aliphatic polyurethanes, which are polyurethanes based on aliphatic polyisocyanate, since these, in contrast to polyurethanes based on aromatic polyisocyanates, do not yellow over the course of time.

Details of the hydrophobic polyurethanes employed in accordance with the invention now follow.

Synthesis components of the hydrophobic polyurethanes are, very generally, compounds having free isocyanate groups and compounds having groups which are reactive with isocyanate groups. Groups which are reactive with isocyanate groups are generally hydroxyl groups and amino groups. Hydroxyl groups are preferred, since the amino groups are very reactive and the reaction mixture must therefore be processed rapidly. The products formed by reaction of these synthesis components are referred to generally below as polyurethanes.

During application of the synthesis components for the hydrophobic polyurethanes it is not necessary for the top layer of the unfixed road or the stones of the track bed to be in a dry state. Surprisingly, even when there are wet stones, effective adhesion is obtained between the polyurethane and the stones. The hydrophobic polyurethane can even be cured under water, since even puddles on the unfixed roads do not substantially detract from the delivery of the polyurethane.

Polyisocyanates used are, as described, aliphatic polyisocyanates. Preferred representatives are hexamethylene diisocyanate (HDI) and isophorone diisocyanate (IPDI). Because of the high volatility of the aliphatic polyisocyantes they are mostly used in the form of their reaction products, particularly as biurets, allophanates or isocyanurates.

Compounds used with at least two hydrogen atoms that are reactive with isocyanate groups are generally polyfunctional alcohols, known as polyols, or, less preferably, polyfunctional amines.

The hydrophobicity of the polyurethanes employed may be brought about in particular through the addition of hydroxyl-functional, fatty-chemical components to at least one of the starting components of the polyurethane system, preferably to the polyol component.

There are a series of hydroxyl-functional, fatty-chemical components known that can be used. Examples are castor oil, hydroxyl-modified oils such as grapeseed oil, black cumin oil, pumpkin seed oil, borage seed oil, soybean oil, wheat germ oil, rapeseed oil, sunflower oil, peanut oil, apricot kernel oil, pistachio kernel oil, almond oil, olive oil, macadamia nut oil, avocado oil, sea buckthorn oil, sesame oil, hazelnut oil, evening primrose oil, wild rose oil, hemp oil, thistle oil, walnut oil, hydroxyl-modified fatty esters based on myristoleic acid, palmitoleic acid, oleic acid, vaccenic acid, petroselinic acid, gadoleic acid, erucic acid, nervonic acid, linoleic acid, linolenic acid, stearidonic acid, arachidonic acid, timnodonic acid, clupanodonic acid, and cervonic acid. Preference here is given to using castor oil and its reaction products with alkylene oxides or ketone-formaldehyde resins. Last-mentioned compounds are sold for example by Bayer AG under the designation Desmophen® 1150.

A further group of fatty-chemical polyols employed with preference can be obtained through ring opening of epoxidized fatty esters with simultaneous reaction with alcohols and, if appropriate, further transesterification reactions subsequently. The incorporation of hydroxyl groups into oils and fats is accomplished primarily by epoxidizing the olefinic double bond present in these products, followed by reaction of the resulting epoxide groups with a monohydric or polyhydric alcohol. This produces, from the epoxide ring, a hydroxyl group or, in the case of polyfunctional alcohols, a structure having a high number of OH groups. Since oils and fats are generally glycerol esters, parallel transesterification reactions run alongside the abovementioned reactions. The compounds obtained in this way preferably have a molecular weight in the range between 500 and 1500 g/mol. Products of this kind are sold for example by Henkel.

The fatty-chemical polyols are used preferably in an amount of >0% to 100% by weight, in particular in an amount of 75% to 100% by weight, based in each case on the total weight of all compounds having at least two hydrogen atoms that are reactive with isocyanate groups.

In one particularly preferred embodiment of the method of the invention the compact polyurethane used is one which is preparable by reacting polyisocyantes with compounds having at least two hydrogen atoms that are reactive with isocyanate groups, characterized in that the compounds having at least two reactive hydrogen atoms comprise at least one fatty-chemical polyol and at least one phenol-modified aromatic hydrocarbon resin, in particular an indene-coumaron resin. These polyurethanes and also their synthesis components have a sufficiently high hydrophobicity that they are able to cure in principle even underwater.

Phenol-modified aromatic hydrocarbon resins having a terminal phenol group that are used are preferably phenol-modified indene-coumaron resins, more preferably technical mixtures of aromatic hydrocarbon resins, particularly those comprising as a significant constituent compounds of the general formula (I)

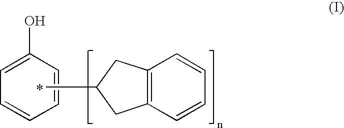

with n from 2 to 28. Products of this kind are commercially customary and are sold for example by Rutgers VFT AG under the trade name NOVARES®.

The phenol-modified aromatic hydrocarbon resins, particularly the phenol-modified indene-coumaron resins generally have an OH content of between 0.5% and 5.0% by weight.

The fatty-chemical polyol and the phenol-modified aromatic hydrocarbon resin, especially the indene-coumaron resin, are preferably employed in a weight ratio of 100:1 to 100:50.

Together with the stated compounds it is possible to use further compounds having at least two active hydrogen atoms. On account of their high resistance to hydrolysis, polyether alcohols are preferred. These alcohols are prepared by customary and known methods, generally by addition reaction of alkylene oxides with H-functional starter substances. The polyether alcohols that are used preferably have a functionality of at least 3 and a hydroxyl number of at least 400 mg KOH/g, preferably at least 600 mg KOH/g, in particular in the range from 400 to 1000 mg KOH/g. They are pre-pared conventionally by reacting at least trifunctional starter substances with alkylene oxides. Starter substances which can be used include, preferably, alcohols having at least 3 hydroxyl groups in the molecule, examples being glycerol, trimethylolpropane, pentaerythritol, sorbitol, and saccharose. The alkylene oxide used is preferably propylene oxide.

The reaction mixture may be admixed with further customary ingredients, examples being catalysts and typical auxiliaries and additives. The reaction mixture ought in particular to be admixed with driers, zeolites for example, in order to prevent the accumulation of water in the components and hence the foaming of the polyurethanes. These substances are added preferably to the compounds having at least two hydrogen atoms that are reactive with isocyanate groups. This mixture is frequently referred to in the art as the polyol component. To improve the long-term stability of the composites it is advantageous to add UV stabilizers.

The polyurethanes employed can be prepared in principle without the presence of catalysts. To improve curing it is possible to employ catalysts. Catalysts selected or preferably ought to be those which result in as long as possible a reaction time. By this means it is possible for the reaction mixture to remain liquid for a long time. In principle it is possible, as described, to operate even entirely without catalyst.

The polyurethanes employed in accordance with the invention preferably comprise no organic compounds comprising silicon atoms. In order to achieve advantageous rheological properties, such as thixotropy, or to achieve relatively high film thicknesses of the cured polyurethane on curved surfaces, however, it is possible to employ inorganic silicon compounds, particularly in the form of pyrogenic silica. The amount employed is preferably >0 than 5 parts by weight.

The combination of the polyisocyanates with the compounds having at least two hydrogen atoms that are reactive with isocyanate groups ought to occur in a ratio such that there is a stoichiometric excess of isocyanate groups, preferably of at least 5%, in particular in the range between 5% and 60%.

The hydrophobic polyurethanes employed with preference are notable for particularly good processing properties. Thus these polyurethanes exhibit effective adhesion on the mineral surface. In spite of the presence of water, the curing of the polyurethanes takes place practically compactly. The compact polyurethanes employed exhibit completely compact curing even in the case of thin layers.

Accordingly the polyurethanes employed with preference are outstandingly suitable for protecting mineral surfaces. The composite form between the mineral surface and the polyurethane is very strong. Moreover, particularly when using very hydrophobic polyurethanes, there is virtually no hydrolytic degradation of the polyurethanes, and hence the mineral surfaces treated by the method of the invention have a very long durability.

In order to implement the method of the invention, the polyisocyanates are preferably mixed with the compounds having at least two active hydrogen atoms and this mixture is applied to the surface, where it cures to the finished polyurethane. Application may take place, for example, by means of spreading, rolling or spraying, in particular by spraying.

The method of the invention allows a simple and durable protection to be achieved by mineral surfaces. The method can be employed in particular in the renovation of outer walls, particularly facades, of buildings. Owing to the hydrophobic finish of the polyurethanes, they provide durable protection to the surface against effects of weathering. Therefore even frost causes hardly any deterioration of the coating. The coating has a longer lifetime than conventional systems, so that the cleaning of facades, which is costly and inconvenient and, particularly in the case of sandblasting, also attacks the facades, can be carried out at relatively long intervals.

Since the coatings are color-stable, they do not detract from the appearance of the building.

1. A method of treating mineral surfaces which comprises the steps of
a) treating the mineral surfaces to remove soiling and
b) coating the surface with a plastic,
which comprises using as the plastic in step b) a transparent, compact hydrophobic polyurethane preparable by reacting i) polyisocyanates with ii) compounds having at least two hydrogen atoms that are reactive with isocyanates.

2. The method according to claim 1, wherein at least one aliphatic polyisocyanate is used as polyisocyanates i).

3. The method according to claim 1, wherein step a) takes place by sandblasting.

4. The method according to claim 1, wherein step a) takes place by waterblasting.

5. The method according to claim 1, wherein the polyurethane employed in step b) has been prepared without using organic compounds comprising silicon atoms.

6. The method according to claim 1, wherein the polyurethanes employed in step b) are prepared using hydroxyl-functional, fatty-chemical components in at least one of the starting components of the polyurethane system.

7. The method according to claim 1, wherein the polyurethanes used in step b) are prepared using hydroxyl-functional, fatty-chemical components as component ii) of the polyurethane system.

8. The method according to claim 1, wherein the polyurethanes employed in step b) are prepared using >0 to 100% by weight, based on the total weight of all compounds having at least two hydrogen atoms that are reactive with isocyanate groups, of hydroxyl-functional, fatty-chemical components in the polyol component of the polyurethane system.

9. The method according to claim 1, wherein the polyurethanes employed in step b) are prepared using >75% to 100% by weight, based on the total weight of all compounds having at least two hydrogen atoms that are reactive with isocyanate groups, of hydroxyl-functional, fatty-chemical components in the polyol component of the polyurethane system.

10. The method according to claim 1, wherein the polyurethanes employed in step b) are prepared using phenol-modified aromatic hydrocarbon resins having a terminal phenol group.

11. The method according to claim 1, wherein the phenol-modified aromatic hydrocarbon resins having a terminal phenol group are phenol-modified indene-coumaron resins.

12. The method according to claim 1, characterized in that the phenol-modified aromatic hydrocarbon resins having a terminal phenol group are phenol-modified indene-coumaron resins of the general formula (I) 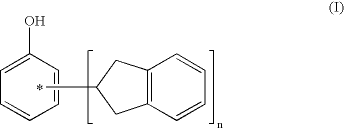
with n from 2 to 28.

13. The method according to claim 1, wherein the liquid starting components of the polyurethane are applied by spraying, rolling or spreading to the mineral surfaces, where they cure to the finished polyurethane.
